(19) United States
(12) Patent Application Publication
(10) Pub. No.: US 2012/0034858 A1
(43) Pub. Date: Feb. 9, 2012

(54) APPARATUS AND METHOD FOR AVOIDING PENETRATION OF FOREIGN PARTICLES INTO A VEHICLE INTERIOR

(75) Inventors: Gregor REICHEL, Ginsheim-Gustavsburg (DE); Christoph FERBER, Novi, MI (US); Alexander WEBER, Gross-Gerau (DE)

(73) Assignee: GM GLOBAL TECHNOLOGY OPERATIONS LLC, Detroit, MI (US)

(21) Appl. No.: 13/198,492

(22) Filed: Aug. 4, 2011

(30) Foreign Application Priority Data
Aug. 5, 2010 (DE) 102010033515.0

(51) Int. Cl. B60H 1/24

(52) U.S. Cl. 454/75

(57) ABSTRACT

Apparatus and method are provided for avoiding penetration of foreign particles into a vehicle interior. An apparatus for avoiding penetration of foreign particles into a vehicle interior including, but not limited to a monitoring device, which detects an expected opening of a vehicle door. In this case an overpressure generating device generates an air overpressure in the vehicle interior.

### CROSS-REFERENCE TO RELATED APPLICATION

This application claims priority to German Patent Application No. 102010033515.0, filed Aug. 5, 2010, which is incorporated herein by reference in its entirety.

### TECHNICAL FIELD

The technical field relates to an apparatus and a method for avoiding penetration of foreign particles into a vehicle interior.

### BACKGROUND

Foreign particles are to be understood within the framework of the present invention, for example, as accumulations of snow, snow fall, accumulations of dirt particles, pollen, and other accumulations of small particles. A vehicle interior can, for example, be a so-called passenger cell or another interior of the vehicle to be protected, for which the avoidance of any penetration of foreign particles is desirable. The foreign particles can be located outside the vehicle, for example, on a vehicle roof, a trunk door, or the covering hood of the vehicle drive (engine hood).

A method and an apparatus for avoiding a rapid variation of the air pressure in a closed space, which is induced by an external environment, can be deduced from German Unexamined Laid-Open Patent Application DE 10 2007 019 014 A1. Here the internal pressure in the space is monitored by a sensor. Rapid variations of the internal pressure are at least partially compensated by specific supply or removal of air. The supply and removal of air is accomplished by opening an overpressure or reduced pressure container.

An air-conditioning device for a vehicle comprising two fans can be deduced from the International Patent Application PCT/EP89/00582 published under the publication number WO 90/01428. The two fans can be controlled by a regulating device in normal operation in such a manner that the air pressure in the passenger compartment is always somewhat higher than the ambient pressure. By means of this air-conditioning device it should be achieved that when doors, windows or sliding roof are closed, any inflow of external air through cracks and joints of the vehicle is counteracted.

Against this background, it is at least one object to provide an apparatus and a method whereby when opening a vehicle door, particles or foreign substances located on the vehicle outer surface or in the vicinity of the vehicle such as snow, dust, droplets and/or accumulations of dirt are prevented from entering into the vehicle interior so that, for example, the vehicle seats are not dirtied or become wet.

### SUMMARY

An apparatus is provided for avoiding penetration of foreign particles into a vehicle interior is provided with a monitoring device, which detects an expected opening of a vehicle door, wherein in this case an overpressure generating device generates an air overpressure in the vehicle interior.

An advantage is in the simple structure for the automatic avoidance of the penetration of foreign particles into the vehicle interior. At the same time, it is additionally avoided that the surfaces of the vehicle interior become dirtied or wet due to the deposition and accumulation of foreign particles. Upon opening a vehicle door, a reduced pressure is usually generated in the vehicle interior through the pivoting movement of the vehicle door so that accumulations of snow, accumulations of dirt, pollen, snowfall etc. located on the vehicle roof, in particular in the gap between the vehicle roof and vehicle door, can enter into the vehicle interior and in particular can dirty or wet the vehicle seats, which can be unpleasant for a person who would like to sit in the vehicle. The overpressure generated in the interior in good time shortly before effectively counteracts this and as it were generates an air flow which emerges from the door frame when the vehicle door is opened. This air thrust very effectively counteracts the entry of foreign particles through the door frame. The term air overpressure is to be understood within the framework of the present invention as an air pressure which is higher than the air pressure of the vehicle environment.

The monitoring device can be formed by a monitoring device already provided in the vehicle, which, for example, by reference to predefined operating parameters detects an expected opening of a vehicle door. It is feasible, for example, that the monitoring device detects when a person is approaching the vehicle or when a person who can be identified as the vehicle driver, for example, by a wireless key, is approaching the vehicle. The overpressure generating device can be designed as an air-filled overpressure tank, which can be disposed both inside the vehicle interior and outside the vehicle interior, e.g., in another vehicle interior. If the overpressure tank is disposed outside the vehicle interior under study, this is connected to the vehicle interior by means of an air-guiding device. The overpressure tank has a particularly high air pressure compared to the vehicle interior. For generating the air overpressure in the vehicle interior, the connection of the overpressure tank to the vehicle interior is opened so that the air flows from the overpressure tank into the vehicle interior and generates an air overpressure there. Further details, aspects, are the subject matter of the dependent claims, the drawings, and the respective description thereof.

In an advantageous embodiment, the generation of the air overpressure takes place subject to the condition that a detection device has detected a foreign particle accumulation located outside the vehicle interior. The overpressure is therefore only generated when the entry of foreign particles into the vehicle interior is to be expected, i.e., when foreign particles are located outside the vehicle interior. The detection device in this case detects, for example, foreign particle accumulations on the vehicle outer surface, in particular foreign particle accumulations on the roof, the windshield, or the hood of the vehicle. In one practical embodiment, the detection device can, for example, be designed as a camera or sensor system for the detection of foreign particle accumulations outside the vehicle interior.

According to a further embodiment, the generation of the air overpressure takes place if the apparatus is set into an avoidance mode. The vehicle driver can thereby specify when the apparatus for avoidance of penetration of foreign particles into the vehicle interior is in operation, i.e., whether avoidance of the penetration of foreign particles is accomplished, as soon as the vehicle door is opened. For example, the apparatus can expediently be put out of operation when the vehicle is parked in a protected area, e.g., in a garage. On the other hand, a vehicle driver can set the apparatus into the avoidance mode, for example, in winter when snow fall is to be expected or when parking the vehicle in a wooded area where increased accumulations of snow can form on the vehicle roof. In this case, the apparatus is so-to-speak activated by setting into the avoidance mode and deactivated (switched off) by taking out of the avoidance mode. The activation or deactivation of the avoidance mode can be accomplished, for example, by actuating a control unit.

According to an embodiment, the monitoring device detects by means of an unlocking of a vehicle door that an opening of the vehicle door is to be expected. By this means, an expected opening of the vehicle door can be identified in a particularly simple manner. The detection can be coupled to a mechanical lock which is opened with a mechanical key or to a wireless lock which is opened by wireless connection by actuating a wireless key.

According to another embodiment, the overpressure generating device comprises a ventilation device. By using, for example, a ventilation device already provided in the vehicle, the generation of the air overpressure can be accomplished at particularly low expense. As soon as the opening of a vehicle door is to be expected or shortly before the opening, the ventilation device increases the air supply and thereby generates the desired air overpressure in the vehicle. The supply of air can, for example, be retained for a predefined time period after the door is opened. This can be advantageous, for example, in the case of snow fall with corresponding wind, since snow could then enter into the vehicle interior for a longer period of time as long as the door is opened.

According to a further embodiment, the ventilation device comprises outlet nozzles which generate a directional air flow. Due to an air flow directed in the direction of the opening vehicle door, the penetration of foreign particles into the vehicle interior is avoided in a particularly optimized manner and with low power consumption of the ventilation device. In this embodiment, outlet nozzles of a ventilation device which are present in the vehicle in any case can advantageously be utilized.

According to a further embodiment, the ventilation device comprises an air supply opening and an air removal opening, wherein the generation of the air overpressure takes place when the air removal opening is closed. The air overpressure in the vehicle interior can thereby be generated in a particularly optimized manner with minimized power consumption of the ventilation device at the same time. In particular, in vehicles having ventilation equipment comprising an air supply opening and an air removal opening, the air overpressure can be produced particularly simply by simply closing the air removal opening.

In a further embodiment, the detection device comprises a rain sensor. Thus, a rain sensor already provided in the vehicle can be used in a particularly expedient manner to detect foreign particles outside the vehicle interior. At the same time, the rain sensor detects accumulations of snow (i.e., ice crystals) located on the outer surface of the vehicle or fine droplets in the same way as liquid accumulations of water caused by rain.

In a further expedient embodiment of the invention, the detection device comprises a temperature sensor. The use of a temperature sensor to detect accumulations of snow outside the vehicle or snow fall is a particularly simple detection variant. The temperature sensor detects, for example, particularly low temperatures and in this case, deduces a high probability of snow accumulations outside the vehicle or snow fall, for example, at temperatures below about 0° Celsius.

According to a further embodiment, the detection device comprises a light sensor. The use of a light sensor as a detection device is advantageous because this can easily be aligned in such a manner that foreign particle accumulations collect between the sun's rays to be detected and the sensor. The sensor detects that the light or sun's rays are broken at the foreign particles or are obscured from the view of the sensor by these, whereby the presence of foreign particles can be concluded. In this case, a sensor already provided in the vehicle, for example, a light-sensitive sensor, can be used to detect foreign particle accumulations.

The method for avoiding the penetration of foreign particles into a vehicle interior provides that an expected opening of a vehicle door is detected, wherein in this case an air overpressure is generated in the vehicle interior. A particularly expedient and simple method is therefore provided, which avoids the penetration of foreign particles into a vehicle interior.

In an advantageous embodiment, an air overpressure is generated when a foreign particle accumulation is detected outside the vehicle interior. This constitutes a particularly expedient further development of the method in which an air overpressure in the vehicle interior is only generated when the penetration of foreign particles into the vehicle interior is to be expected when opening the vehicle door.

### BRIEF DESCRIPTION OF THE DRAWINGS

The present invention will hereinafter be described in conjunction with the following drawing figures, wherein like numerals denote like elements, and:

FIG. 1 shows an exemplary embodiment of an apparatus according to the invention;

FIG. 2 shows an exemplary embodiment of an apparatus according to the invention, and

FIG. 3 shows schematically an embodiment of the sequence of the method according to the invention.

### DETAILED DESCRIPTION

The following detailed description is merely exemplary in nature and is not intended to limit application and uses. Furthermore, there is no intention to be bound by any theory presented in the preceding background or summary or the following detailed description.

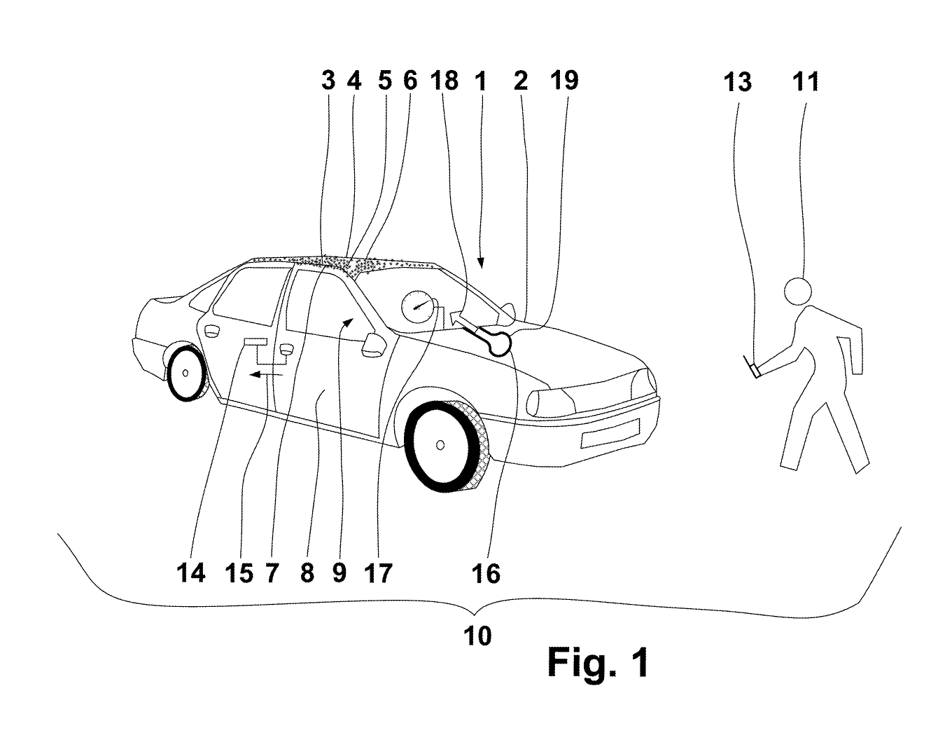

FIG. 1 shows an apparatus 1 according to an embodiment in a vehicle 2, which is at a standstill in the situation shown, wherein foreign particles 3 are located on the roof 4 of the vehicle 2. The foreign particles 3 form a foreign particle accumulation 5 in the form of a snow accumulation 6. The snow accumulation 6 is additionally located in a gap 7 between the roof 4 and the vehicle door 8. In this case, the vehicle door 8 is closed and the snow accumulation 6 does not enter into a vehicle interior 9 in the situation shown.

Located in the vehicle environment 10 is a vehicle driver 11, who sets the apparatus 1 into an avoidance mode by actuating a radio control element 13, i.e., activates the apparatus. The vehicle driver 11 then unlocks the vehicle door 8 by actuating the radio control unit 13. A monitoring device 14 detects that the vehicle door 8 has been unlocked and thereby deduces an expected opening 15 of the vehicle door 8. In this case, an overpressure generating device 16 generates an air overpressure 17 in the vehicle interior 9 by supplying air 18 into the vehicle interior 9 via a ventilation device 19.

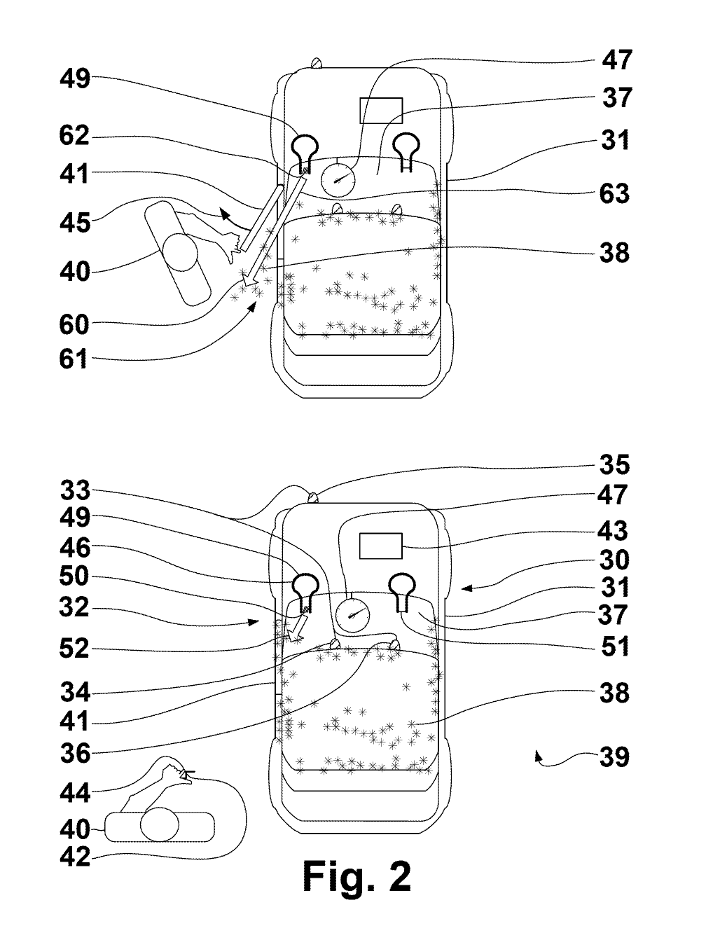

FIG. 2 shows an apparatus 30 according to an embodiment of the invention in a vehicle 31 viewed from above (e.g., a bird's eye view), which is at a standstill in the situation 32 shown (in FIG. 2 below). In this case, a detection device 33 comprises a rain sensor 34, a temperature sensor 35, and a light sensor 36, which each detect a foreign particle accumulation 38 located outside the vehicle interior 37.

The rain sensor 34 thereby detects precipitation in the form of rain or snow fall, accumulations of water and snow outside the vehicle interior 37, and in this case emits a detection signal. The temperature sensor 35 in particular detects temperatures below about 0° Celsius which gives reason to expect snow accumulations located outside the vehicle interior 37 or snow fall. Upon detecting these temperatures, the temperature sensor 35 emits a detection signal. The light sensor 36 additionally detects foreign particle accumulations 38 located between light or sun's rays to be detected and the light sensor 36. This is accomplished by the light sensor 36 detecting that light or sun's rays are broken at the foreign particles or are obscured from the view of the light sensor 36 by these particles. In this case, the presence of foreign particle accumulations 38 outside the vehicle interior 37 can be deduced so that the light sensor 36 emits a detection signal. The emitted detection signal of the rain sensor 34, temperature sensor 35, and/or light sensor 36 have the result, for example, in an automatic mode of the apparatus 30, that the apparatus 30 is set into an avoidance mode, i.e., is activated. If the rain sensor 34 and the light sensor 36 detect no foreign particle accumulations 38 and if the temperature sensor 35 detects temperature above about 0° C., a corresponding signal is emitted so that the apparatus does not enter into the avoidance mode and/or this is deactivated again.

Located in the environment 39 of the vehicle 31 is a vehicle driver 40, who unlocks a vehicle door 41 using a vehicle key 42. The vehicle key 42 is thereby connected by radio to the door lock and to a monitoring device 43. The monitoring device 43 detects an expected opening 45 (shown at the top in FIG. 2) of the vehicle door 41 by means of the unlocking 44 of the vehicle door 41. An overpressure generating device 46 then generates an air overpressure 47, i.e., a higher air pressure compared to the air pressure in the vehicle environment, in the vehicle interior 37. The overpressure generating device 46 in this case is a ventilation device 49. The ventilation device 49 has an air supply opening 50 and an air removal opening 51, and generate the air overpressure 47 in the vehicle interior 37 by supplying air 52, the air removal opening 51 being closed.

At the top of FIG. 2 the vehicle 31 is shown at a later time after the vehicle driver 40 has opened the vehicle door 41. At this moment foreign particle accumulations 38 fall down and are blown away from the vehicle interior 37 by the air flow 60, which emerges from the opening 61 of the vehicle door 41 through a vehicle door frame. For this purpose the ventilation device 49 generates a directed air flow 63 through outlet nozzles 62, which is directed toward the opening 61 of the vehicle door 41 when viewed from the vehicle interior 37.

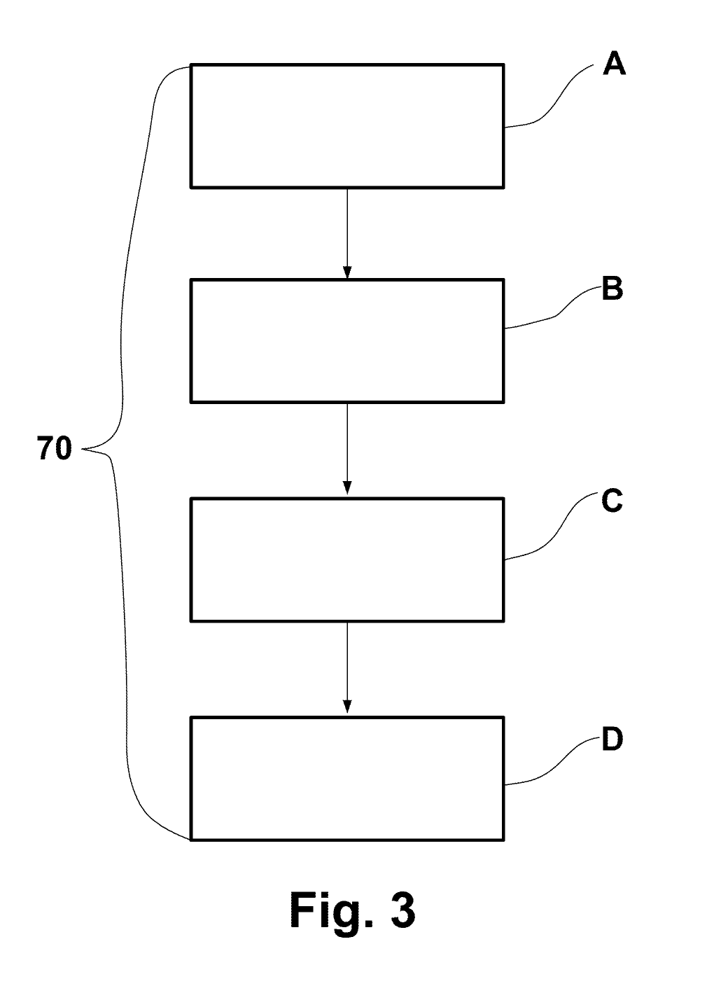

FIG. 3 shows schematically a possible sequence of the method 70 according to an embodiment of the invention. The method begins in process step A, in which a foreign particle accumulation is detected outside the vehicle interior. In a further process step B the vehicle door is unlocked. By means of the unlocking of the vehicle door, an expected opening of the vehicle door is detected in a further process step C. In this case, an air overpressure in the vehicle interior is generated in a following process step D.

While at least one exemplary embodiment has been presented in the foregoing summary and the detailed description, it should be appreciated that a vast number of variations exist. It should also be appreciated that the exemplary embodiment or exemplary embodiments are only examples, and are not intended to limit the scope, applicability, or configuration way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An apparatus for avoiding penetration of foreign particles into a vehicle interior comprising:
a monitoring device configured to detect an expected opening of a vehicle door; and
an overpressure generating device configured to generate an air overpressure in the vehicle interior upon detection of the expected opening of the vehicle door by the monitoring device.

2. The apparatus according to claim 1, further comprising a detection device, wherein the overpressure generating device is configured to generate the air overpressure subject to a condition that a foreign particle accumulation located outside the vehicle interior is detected by the detection device.

3. The apparatus according to claim 1, wherein the overpressure generating device is configured to generate the air overpressure in an avoidance mode.

4. The apparatus according to claim 1, wherein the monitoring device is configured to detect an unlocking of the vehicle door indicative that an expected opening of the vehicle door.

5. The apparatus according to claim 1, wherein the overpressure generating device comprises a ventilation device.

6. The apparatus according to claim 5, wherein the ventilation device comprises outlet nozzles configured to generate a directional air flow.

7. The apparatus according to claim 6,
wherein the ventilation device comprises an air supply opening and an air removal opening, and
wherein the overpressure generating device is configured to generate the air overpressure when the air removal opening is at least substantially closed.

8. The apparatus according to claim 2, wherein the detection device comprises a rain sensor.

9. The apparatus according to claim 2, wherein the detection device comprises a temperature sensor.

10. The apparatus according to claim 2, wherein the detection device comprises a light sensor.

11. A method for avoiding penetration of foreign particles into a vehicle interior, comprising:
detecting an expected opening of a vehicle door with a monitoring device; and
generating an air overpressure in the vehicle interior an overpressure generating device.

12. The method according to claim 11, further comprising:
detecting a foreign particle accumulation outside the vehicle interior with a detection device; and
generating the air overpressure when the foreign particle accumulation is detected outside the vehicle interior.

13. The method according to claim 11, further comprising:
entering an avoidance mode; and
generating the air overpressure when in the avoidance mode.

14. The method according to claim 11, further comprising detecting an unlocking of the vehicle door indicative that an expected opening of the vehicle door.

15. The method according to claim 12, wherein the overpressure generating device comprises a ventilation device.

16. The method according to claim 15, wherein the ventilation device comprises outlet nozzles configured to generate a directional air flow.

17. The method according to claim 16, wherein the ventilation device comprises an air supply opening and an air removal opening, and the method further comprises generating the air overpressure when the air removal opening is at least substantially closed.

18. The method according to claim 12, wherein the detection device comprises a rain sensor.

19. The method according to claim 12, wherein the detection device comprises a temperature sensor.

20. The method according to claim 12, wherein the detection device comprises a light sensor.
